(19) United States
(12) Patent Application Publication
(10) Pub. No.: US 2014/0283790 A1
(43) Pub. Date: Sep. 25, 2014

(54) COMMON RAIL FUEL INJECTION SYSTEM

(71) Applicants: HINO MOTORS, LTD., Tokyo (JP); USUI KOKUSAI SANGYO KAISHA LTD., Shimizu-cho, Sunto-gun, Shizuoka (JP)

(72) Inventors: Shuji Suzuki, Shimizu-cho (JP); Koichi Hayashi, Shimizu-cho (JP); Mori Ishii, Hino-shi (JP); Kiyohiro Shimokawa, Hino-shi (JP); Hiroshi Nakajima, Tokyo (JP)

(73) Assignees: USUI KOKUSAI SANGYO KAISHA LTD., Shimizu-cho, Sunto-gun, Shizuoka (JP); HINO MOTORS, LTD., Tokyo, (JP)

(21) Appl. No.: 14/349,199

(22) PCT Filed: Oct. 2, 2012
(86) PCT No.: PCT/JP2012/075515

§ 371 Date: Apr. 2, 2014

(30) Foreign Application Priority Data
Oct. 3, 2011 (JP) 2011-219633

(51) Int. Cl. F02M 55/02

(52) U.S. Cl. CPC F02M 55/025
USPC 123/456

(57) ABSTRACT

A common rail fuel injection system includes injectors having a fuel intake port and being provided for respective cylinders of a multi-cylinder diesel internal combustion engine, a common rail accumulating pressurized fuel, a high-pressure supply pump supplying high-pressure fuel, a fuel supply pipe causing the common rail and the high-pressure supply pump to communicate with each other. The fuel injection pipes communicating with pressure supply ports provided in the common rail and causing the injectors and the pressure supply ports to communicating with each other. The fuel injection pipes cause at least three injectors to communicate with one another in series. The number N_{P} of pressure supply ports is less than the number P_{I} of injectors, and supply of high-pressure fuel to the respective injectors for the cylinders is performed through fuel injection pipes of two lines.

### BACKGROUND

1. Field of the Invention

The present invention relates to a common rail fuel injection system for a diesel internal combustion engine, and more specifically to a common rail fuel injection system which is used in a diesel internal combustion engine and accumulates pressurized fuel in a common rail to inject the same into each cylinder.

2. Description of the Related Art

A common rail fuel injection system for a diesel internal combustion engine is a fuel injection system of an electromagnetic control type which accumulates high-pressure fuel in a common rail by a high-pressure supply pump to inject high-pressure fuel accumulated in the common rail into each cylinder, and a conventional common rail fuel injection system for a diesel internal combustion engine is shown in FIG. 28.

The structure of the common rail fuel injection system is provided with an injector provided for each cylinder in a diesel internal combustion engine, a common rail for accumulating pressurized fuel to be supplied to the injector, a high-pressure fuel supply pump which supplies high-pressure fuel to the common rail, a fuel injection pipe which causes the common rail and the injector to communicate with each other, and a fuel supply pipe which causes the common rail and the high-pressure supply pump to communicate with each other.

In such a common rail fuel injection system, a means is desired which can suppress pressure fluctuation within the injector due to fuel injection (pressure drop at an injection time) by a simple means and can obtain an even injection pressure characteristic without increasing the sizes of the common rail and the fuel injection pipe.

In the conventional art shown in FIG. 28, it is necessary to reduce a pressure drop amount at an injection time in order to suppress the pressure fluctuation within the injector due to fuel injection (pressure drop at an injection time) and obtain the even injection pressure characteristic. Therefore, it is effective to adopt an injection pipe with a larger inner diameter. On the other hand, though further pressure increase in the common rail system is also required in the future in order to suppress exhaust of smoke, when the inner diameter of the injection pipe is enlarged, it is necessary to improve inner-pressure fatigue strength performance, so that it is necessary to make a pipe strength higher than an existing material. Therefore, it is required to carefully select a fuel pipe material and adopt an expensive manufacturing process, so that rising of a manufacturing cost becomes essential.

The present applicant has proposed a technique shown in Japanese Patent Application Laid-Open No. 2007-182792 to such a problem. A representative example of the technique is shown in FIG. 29.

In Japanese Patent Application Laid-Open No. 2007-182792, as shown in FIG. 29, internal volumes of a common rail 22, fuel injection pipes 23 and injectors 21 are secured by connecting injectors 21 positioned adjacent to each other by a pipe 26 to cause inside of the pipe 26 to function as a sub-pressure accumulation chamber and providing another connection portion different from a connection portion with a fuel injection pipe 23 within a high-pressure flow path for introducing high-pressure fuel from a common rail 22 into the injector 21 via the fuel injection pipe 23 or within a high-pressure flow path inside the injector 21 to which pressure fluctuation due to fuel injection is transmitted as a means for connecting the injectors 21 adjacent to each other by the pipe 26, and connecting the pipe 26 to the another connection portion to perform connection with the same connection portions of the injectors of cylinders adjacent to each other, so that a fuel injection system having a good responsiveness and an accurate injection characteristics is obtained by enhancing responsiveness of fuel injection (follow-up performance to an instruction signal from a vehicle-mounted CPU) and preventing pressure drop within the injector due to fuel injection without enlarging the inner diameters of the common rail and the fuel injection pipe or increasing the lengths thereof.

Further, in FIG. 10 of Japanese Patent Application Laid-Open No. H10-30521, injection valves 2 are arranged corresponding to combustion chambers of respective cylinders of an engine, and fuel is injected to the combustion chambers of the respective cylinders in the determined order of the cylinders, for example, in the order of cylinders #1, #3, #4, and #2 according to ON and Off of injection-control solenoid valves 3. These injection valves 2 are connected to a common rail 5 common to the respective cylinders via branch supply pipes 4 having a first fuel passage 14 shown in FIG. 1. Further, high-pressure fuel is accumulated up to a predetermined pressure in a pressure accumulation chamber 15 formed in the common rail 5, and the high-pressure fuel accumulated in the pressure accumulation chamber 15 is injected into the combustion chambers of the respective cylinders of the engine 1 from the injection valves 2 via the branch supply pipes 4 during openings of the solenoid valves 3. Further, the branch supply pipes 4 adjacent to each other are connected by a coupling pipe 61, 62, or 63 as pulsation reducing machine, so that rigidity of the branch supply pipes 4 are enhanced.

Therefore, a fuel injection device which can reduce vibration amplitudes of the branch supply pipes 4 serving as thin pipes has been proposed.

Further, a accumulator type fuel injection device proposed on FIG. 2 of Japanese Patent Application Laid-Open No. 2000-161171 is configured to pool fuel pressurized by a high-pressure fuel pump 1 in a high-pressure accumulator 3 communicating with a fuel passage 10a and common to respective cylinders, but, for example, selector valves (first control valves) 5 for fuel injection rate switching composed of a two-directional solenoid valve are provided for respective cylinders in the halfway of the fuel passage 10a, and check valves 32 which allow only flow of fuel from an upstream side to a downstream side are provided just downstream of the selector valves 5. Further, a low-pressure accumulator (second pressure accumulator) 4 common to the respective cylinders is connected to the fuel passage 10a via fuel passages 10b branched from the fuel passage 10a downstream of the check valves 32.

Further, a check valve 6 and a bypass passage for bypassing the check valve 6 are provided in the branched fuel passage 10b, and an orifice 6a is provided in the bypass passage. The check valve 6 allows only flow of fuel from the low-pressure accumulator 4 in the direction of the fuel passage 10a.

That is, when the fuel pressure in the fuel passage 10a is higher than the fuel pressure in the branched fuel passage 10b, fuel within the fuel passage 10a flows in the branched fuel passage 10b via the orifice 6a and further flows into the low-pressure accumulator 4, thereby suppressing fluctuation of the fuel pressure.

In such conventional arts as proposed in Japanese Patent Application Laid-Open No. 2007-182792, Japanese Patent Application Laid-Open No. H10-30521 and Japanese Patent Application Laid-Open No. 2000-161171 it is possible to suppress pressure fluctuation within an injector due to fuel injection and obtain an even injection pressure characteristic by increasing a pressure accumulation volume, but there is such a drawback that a structure for achieving such an effect is complicated, which results in increase in device weight.

In view of these circumstances, an object of the present invention is to provide a common rail fuel injection system which, by a simple means, can suppress pressure fluctuation within an injector due to fuel injection, can obtain an even fuel injection pressure characteristic and can reduce harmful exhaust gas from a diesel internal combustion engine, without enlarging the sizes of a common rail and a fuel injection pipe.

### SUMMARY OF THE INVENTION

A first aspect of the present invention is a common rail fuel injection system including injectors having a fuel intake port and being provided in respective cylinders of a multi-cylinder diesel internal combustion engine; a common rail accumulating pressurized fuel supplied to the injectors; a high-pressure supply pump supplying high-pressure fuel to the common rail; a fuel supply pipe causing the common rail and the high-pressure supply pump to communicate with each other; and fuel injection pipes communicating with pressure supply ports provided in the common rail and causing the injectors and the pressure supply ports provided in the common rail to communicate with each other, wherein the fuel injection pipes communicate with at least three injectors in series, the number NP of pressure supply ports provided in the common rail is less than the number NI of injectors, and supply of high-pressure fuel to the respective injectors for the cylinders is performed through the fuel injection pipes of two lines.

A second aspect of the present invention is the common rail fuel injection system according to the first aspect, where the multi-cylinder diesel internal combustion engine is a diesel internal combustion engine having at least three cylinders.

A third aspect of the present invention is the common rail fuel injection system according to the first or second aspect, where the multi-cylinder diesel internal combustion engine is a diesel internal combustion engine having at least three injectors.

A fourth aspect of the present invention is the common rail fuel injection system according to any one of the first to third aspects, where a relationship between the number of pressure supply ports provided in the common rail and the number of injectors is set such that the number of twice the number obtained by dividing the number NI of injectors by an aliquot which is three or more in aliquots of the number N_{I} of injectors coincides with the number N_{P} of pressure supply ports as shown in the following Equation (1).

N_{P}=2×{N_{I}/(an aliquot which is three of more in aliquots of N_{I})} (1)

According to the present invention, it is made possible to reduce an exhaust amount of smoke as compared with the conventional structure by suppressing pressure pulsation generated due to injection and reducing an pressure drop amount at an injection time to improve an average value of pressures during injection (hereinafter, referred to as “average injection pressure value).

Further, since reduction of a peak pressure acting on the injection pipe can be made possible, the reduction is advantageous regarding an internal pressure fatigue strength performance of the injection pipe, a set pressure to the common rail system can be raised, and an exhaust amount of smoke can be suppressed.

In addition, since the average injection pressure value can be increased, it is unnecessary to elevate the injection pressure of the common rail system itself beyond necessity so that size reduction of the common rail system (the pump, the common rail, and the injector) can be achieved.

Furthermore, an improvement effect of fuel consumption can also be obtained according to the above operation.

### BRIEF DESCRIPTION OF THE DRAWINGS

FIG. 1 is a schematic view for explaining a fuel injection system of the present invention.

FIG. 2A is a diagram showing pressure change within a fuel injection pipe at a fuel injection time and showing an operating state of an injection needle valve at a rotational angle of a crank shaft.

FIG. 2B is a diagram showing pressure change within a fuel injection pipe at a fuel injection time and showing a pressure change within the fuel injection pipe in the state shown in FIG. 2A.

FIG. 3 is a diagram showing average pressures within the fuel injection pipe before and after fuel injection and during fuel injection.

FIG. 4 is a diagram showing an exhaust amount of smoke in a real machine of an engine.

FIG. 5 is a diagram showing a fuel consumption according to BSFC index.

FIG. 6 is a diagram showing a value obtained by dividing an average pressure within an injection pipe by a whole volume of a fuel injection system, namely, an average pressure within an injection pipe per unit volume of a fuel injection system.

FIG. 7 is a schematic view for explaining a fuel injection system according to Example 1.

FIG. 8 is a schematic view for explaining a fuel injection system according to Example 2.

FIG. 9 is a schematic view for explaining a fuel injection system according to Example 3.

FIG. 10 is a schematic view for explaining a fuel injection system according to Example 4.

FIG. 11 is a schematic view for explaining a fuel injection system according to Example 5.

FIG. 12 is a schematic view for explaining a fuel injection system according to Example 6.

FIG. 13 is a schematic view for explaining a fuel injection system according to Example 7.

FIG. 14 is a schematic view for explaining a fuel injection system according to Example 8.

FIG. 15 is a schematic view for explaining a fuel injection system according to Example 9.

FIG. 16 is a schematic view for explaining a fuel injection system according to Example 10.

FIG. 17 is a schematic view for explaining a fuel injection system according to Example 11.

FIG. 18 is a schematic view for explaining a fuel injection system according to Example 12.

FIG. 19 is a schematic view for explaining a fuel injection system according to Example 13.

FIG. 20 is a schematic view for explaining a fuel injection system according to Example 14.

FIG. 21 is a schematic view for explaining a fuel injection system according to Example 15.

FIG. 22 is a schematic view for explaining a fuel injection system according to Example 16.

FIG. 23 is a schematic view for explaining a fuel injection system according to Example 17.

FIG. 24 is a schematic view for explaining a fuel injection system according to Example 18.

FIG. 25 is a schematic view for explaining a fuel injection system according to Example 19.

FIG. 26 is a schematic view for explaining a fuel injection system according to Example 20.

FIG. 27 is a schematic view for explaining a fuel injection system according to Example 21.

FIG. 28 is a schematic view of a fuel injection system according to a conventional example.

FIG. 29 is a schematic view of a fuel injection system.

### DETAILED DESCRIPTION OF THE PREFERRED EMBODIMENTS

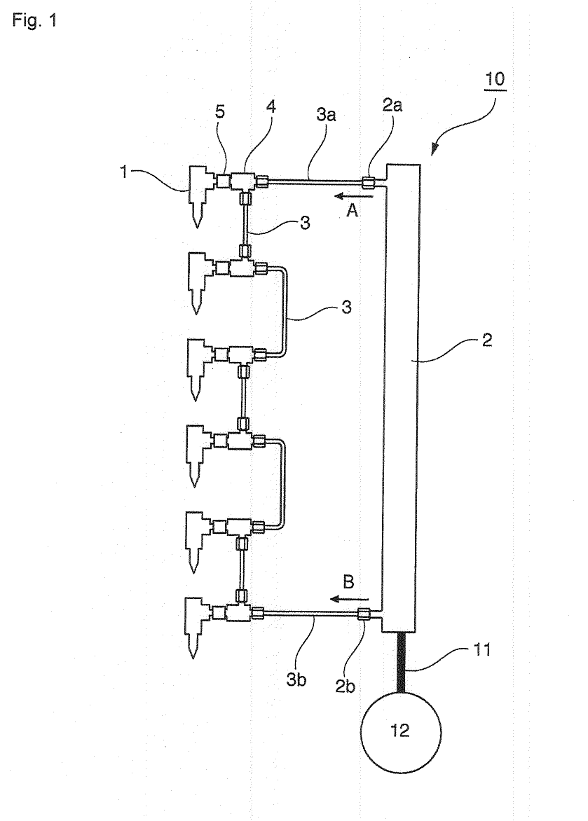

FIG. 1 is a schematic view for explaining a fuel injection system of the present invention, which corresponds to a 6-cylinder diesel internal combustion engine.

In FIG. 1, reference sign 1 denotes an injector; 2 denotes a common rail; 2a, 2b denotes a pressure supply port; 3 denotes a fuel injection pipe; 3a, 3b denotes a fuel injection pipe communicating with each of the pressure supply ports 2a and 2b of the common rail; 4 denotes a coupling connector; 5 denotes a connection nut; 11 denotes a fuel injection pipe; 12 denotes a high-pressure supply pump; and 10 denotes a fuel injection system of the present invention.

A case where the number NP of pressure supply ports is two, the number NI of injectors 1 is six, and the number of twice the number obtained by performing division by 6 which is an aliquot which is three or more in aliquots of the number N_{I} is the number N_{P} of pressure supply ports is shown.

Here, the fuel injection pipes 3a and 3b communicate with the pressure supply ports 2a and 2b of the common rail 2, respectively, and they are for supplying high-pressure fuel to the fuel injection pipes 3 communicating with six injectors 1 in a series.

Further, summarizing the relationship between the number NP of pressure supply ports and the number NI of injectors 1, a relationship shown by the following Equation (2) is obtained, and the relationship in an actual multi-cylinder diesel internal combustion engine (three cylinders to eight cylinders) is shown in Table 1. The relationship of Equation (2) can also be applied to even a diesel internal combustion engine having further more cylinders.

Equation (2)

N_{P}=2×{N_{I}/(an aliquot which is three or more in aliquots of N_{I})} (2)

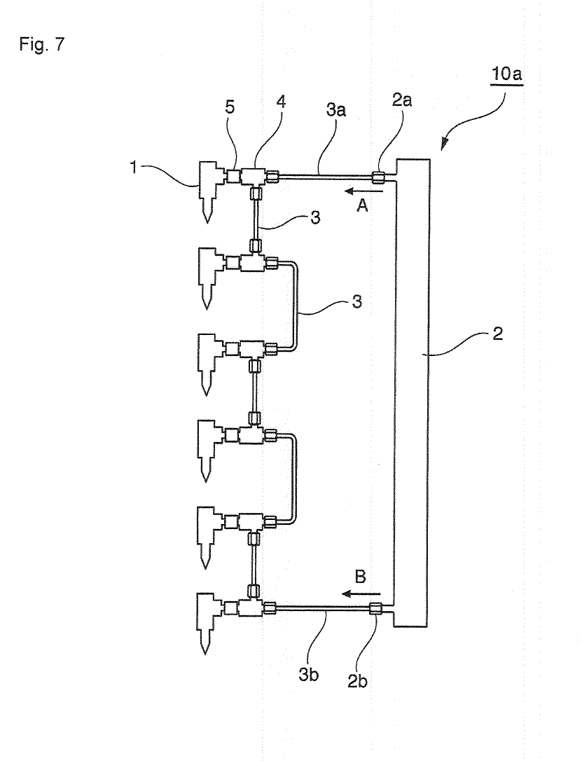

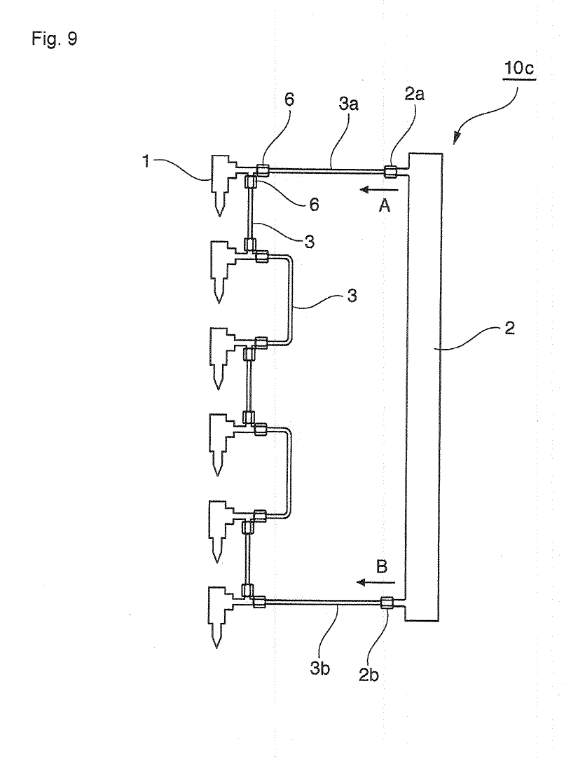

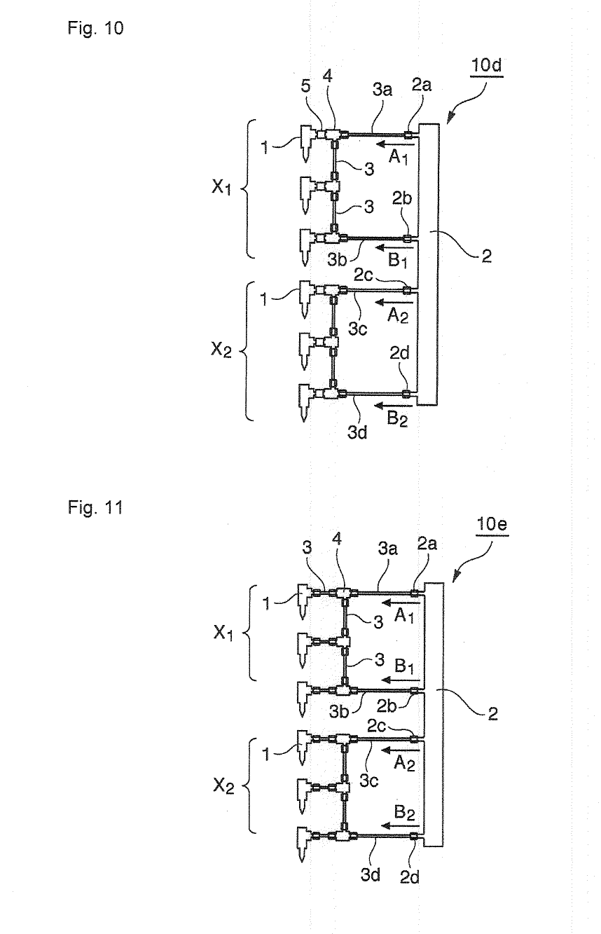

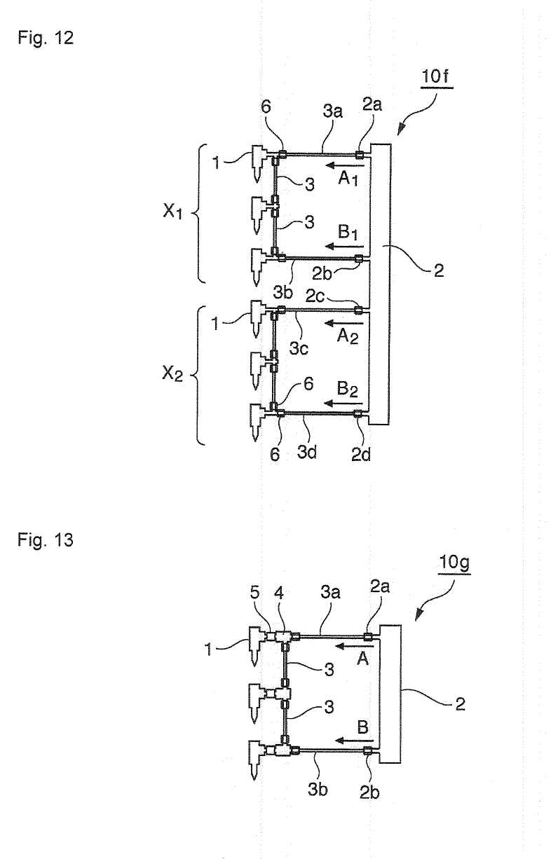

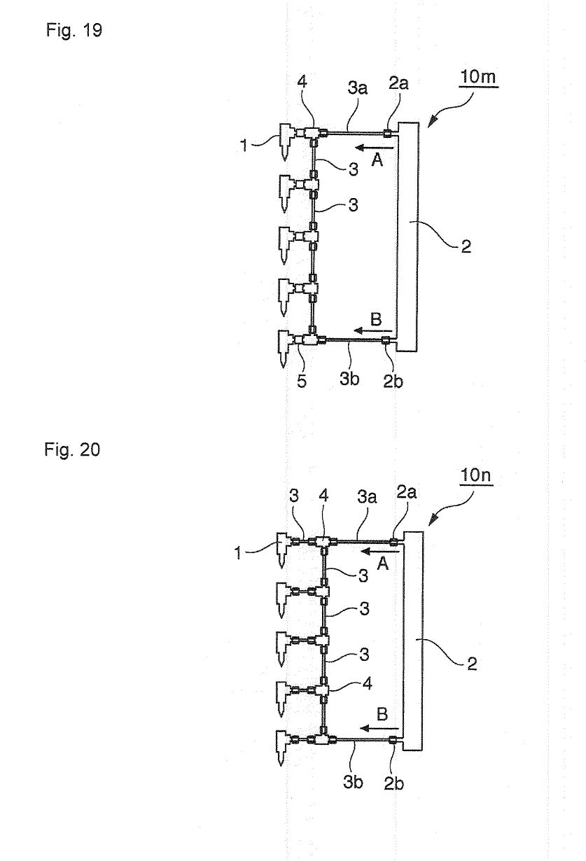

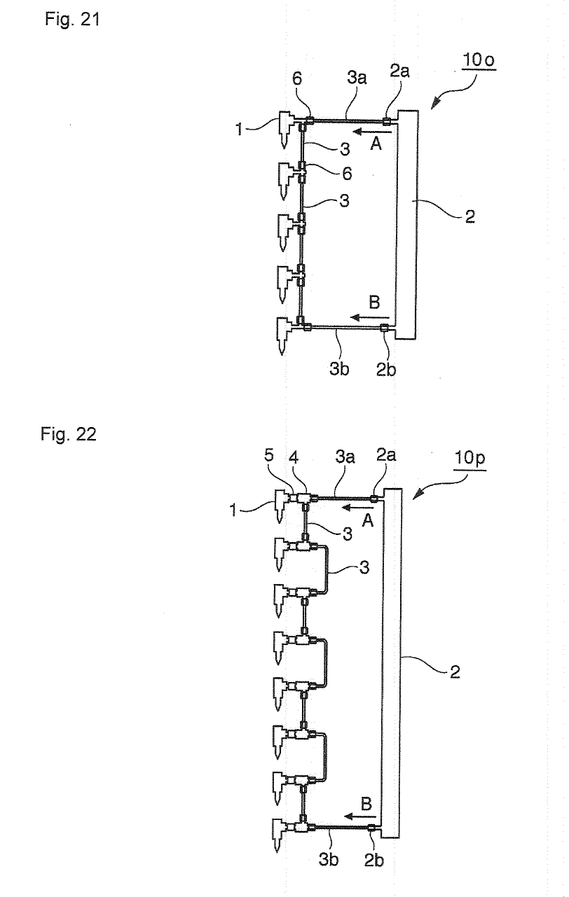

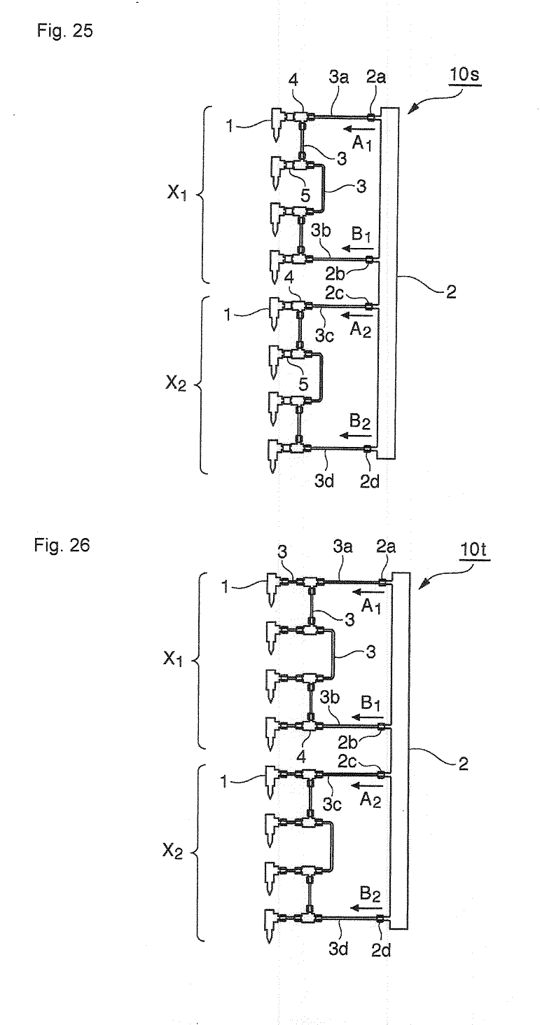

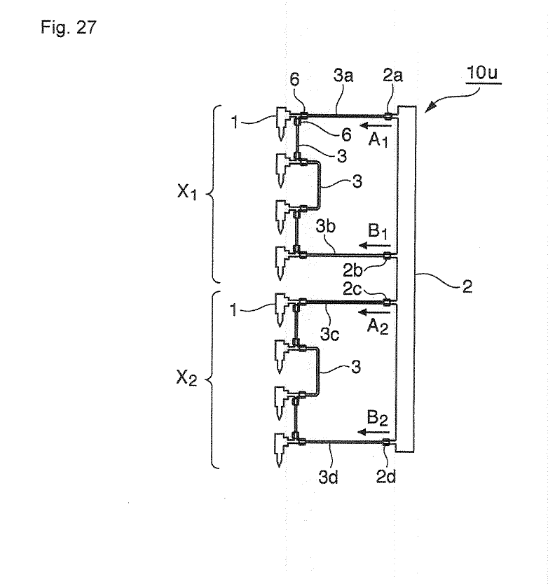

TABLE 1

| | | The number | | |
|---|---|---|---|---|
| | The number | of pressure | Example | |
| The number | of injectors | supply ports in | | Reference |
| of cylinders | N_{I} | common rail N_{P} | No. | Figure |
| three | three | two points | Examples 7 | FIG. 13 to |
| cylinders | | | to 9 | FIG. 15 |
| four | four | two points | Examples 10 | FIG. 16 to |
| cylinders | | | to 12 | FIG. 18 |
| fifth | five | two points | Examples 13 | FIG. 19 to |
| cylinders | | | to 15 | FIG. 21 |
| six | six | two points | Examples 1 | FIG. 7 to |
| cylinders | | | to 3 | FIG. 9 |
| | | four points | Examples 4 | FIG. 10 to |
| | | | to 6 | FIG. 12 |
| eight | eight | two points | Examples 16 | FIG. 22 to |
| cylinders | | | to 18 | FIG. 24 |
| | | four points | Examples 19 | FIG. 25 to |
| | | | to 21 | FIG. 27 |

In FIG. 1, high-pressure fuel is supplied to each injector 1 in such an aspect that fuels fed from two lines of a fuel supply line A extending through the fuel injection pipe 3a and fed from a fuel supply line B extending through the fuel injection pipe 3b are mixed at each coupling connector 4 before fuel intake into the injector 1, for example, as shown in FIG. 1.

By supplying fuels from the two lines, namely from two directions in this manner, fuel pressure after mixing becomes an average pressure of the two lines so that pressure fluctuation (pulsation) is relaxed.

How to mix fuels supplied from routes of the two lines must be performed before fuel injection into cylinders, as shown in the fuel injection system of FIG. 1. Therefore, a method for performing coupling and mixing simultaneously using parts such as the coupling connectors 4 for coupling fuel routes, a method for performing mixing of fuels in an injector by providing two fuel intake ports in an injector and causing fuel injection pipes of respective fuel routes to communicate with the respective fuel intake ports, or the like is proposed.

Additionally, in explanation using FIG. 1, the case where the number NP of pressure supply ports provided in the common rail is an even number corresponding to one set of two ports is described, but when the number of pressure supply ports is an odd number, for example, the pressure supply ports may be provided as one set of three ports.

### EXAMPLE

The present invention will be further described below using Examples.

### Example 1

FIG. 7 is a schematic view of a fuel injection system 10a according to Example 1 (a case where same devices such as the fuel supply pipe and the high-pressure supply pump are used is not shown in the figures described below).

In FIG. 7, reference sign 1 denotes an injector; 2 denotes a common rail; 2a, 2b denotes a pressure supply port provided in the common rail 2; 3, 3a, 3b denotes a fuel injection pipe; 4 denotes a coupling connector; and 5 denotes a connection nut.

The fuel injection system 10a of Example 1 is one for a 6-cylinder diesel internal combustion engine, which has six injectors 1 (NI=6) and supplies high-pressure fuels to the six injectors 1 connected in series from the pressure supply ports 2a and 2b provided in the common rail 2 having two ports {(N_{P}=2×(6/6))} through the fuel injection pipes 3a and 3b communicating with the pressure supply ports 2a and 2b, respectively.

In the fuel injection system 10a of Example 1, supply of fuel to each injector 1 is performed such that fuels are fed to a coupling connector 4 from two directions of the fuel supply line A where fuel is fed through the pressure supply port 2a and the fuel injection pipe 3a and the fuel supply line B where fuel is fed through the pressure supply port 2b and the fuel injection pipe 3b, and after pressures of the fuels are averaged in the coupling connector 4, the fuels are fed to an injector 1 coupled to the coupling connector 4 by a connection nut 5 to be injected into a corresponding cylinder.

### Conventional Example

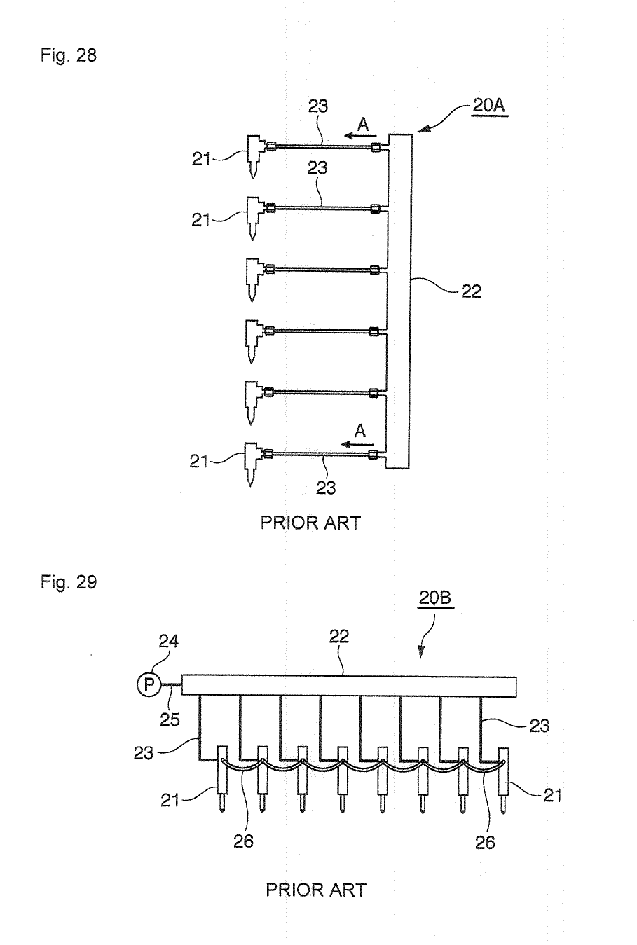

As the conventional example, the fuel injection system shown in FIG. 28 was used.

In FIG. 28, reference sign 20A denotes a fuel injection system of the conventional example; 21 denotes an injector; 22 denotes a common rail; and 23 denotes a fuel injection pipe, but the fuel supply pipe, the high-pressure supply pump and the like are not shown.

The fuel injection system 20A shown in FIG. 28 is a fuel injection system corresponding to a 6-cylinder diesel internal combustion engine like Example 1, where six fuel injection pipes individually communicating with respective six injectors 21 from the common rail 22 to supply high-pressure fuel to the six injectors 21 communicate with six pressure supply ports of the common rail.

[Performance Comparison of the Fuel Injection System with the Present Invention]

Pressure fluctuation within the injection pipe at fuel injection time, behaviors of exhaust gases and fuel consumption behaviors were measured using the fuel injection systems of Example 1 (the fuel injection system 10a shown in FIG. 7) and the conventional example (the fuel injection system 20A shown in FIG. 28).

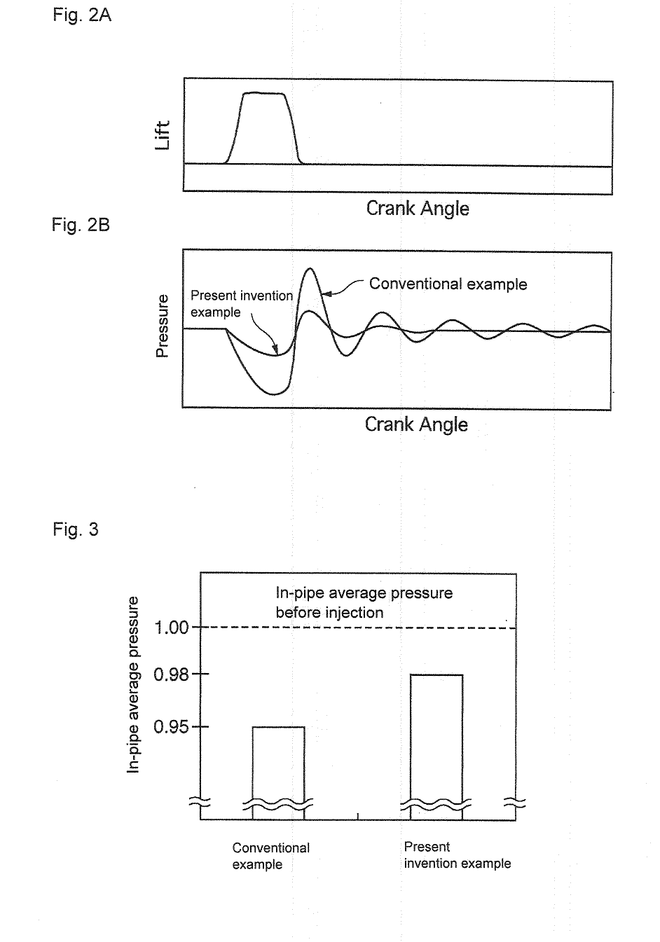

The result will be explained with reference to FIG. 2 to FIG. 6.

In FIGS. 2A and 2B, Crank Angle of an engine is plotted along a horizontal axis, and an operation amount of an injector needle valve is plotted along a vertical axis in FIG. 2A, while an injection pipe internal pressure is plotted along a vertical axis in FIG. 2B. Where lift-up was performed at a certain angle, the conventional example (the fuel injection system 20A shown in FIG. 28) and Example 1 (the fuel injection system 10a shown in FIG. 7) were compared with each other.

It is understood that in the conventional example receiving fuel supply from one direction, large pressure drop and pressure fluctuation occur due to the lift, but in the present invention Example receiving fuel supply from two directions, since fuel supply is promoted, pressure drop and pressure fluctuation can be suppressed.

FIG. 3 is a diagram showing average pressures within the injection pipe before and after fuel injection and during fuel injection, where the fuel injection systems of the conventional example and Example 1 are compared with each other.

A combustion efficiency is generally enhanced by obtaining a high average injection pressure, so that reduction of an exhaust amount of smoke and improvement of the fuel consumption can be obtained.

From FIG. 3, it is understood that the average injection pressure is 95% of a pressure before injection in the conventional example, while a high pressure up to 98% can be obtained in the present invention example.

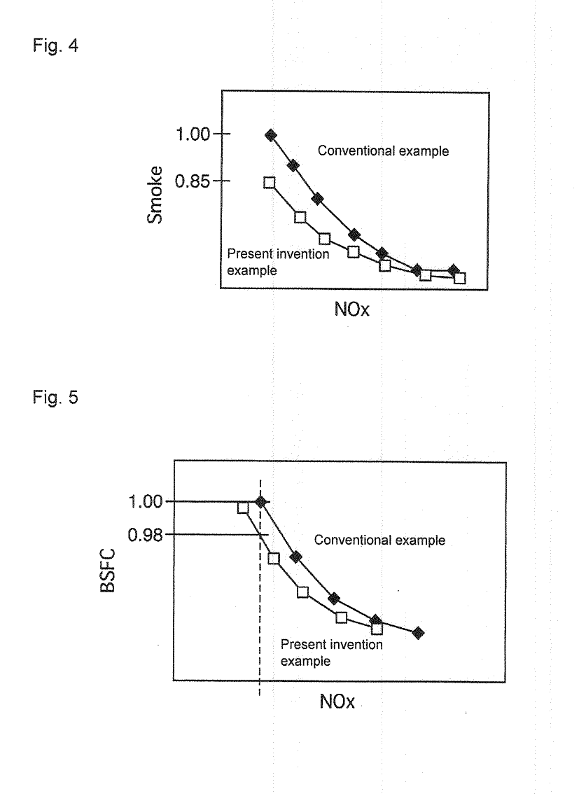

FIG. 4 is a diagram where comparison about a relationship between an exhaust amount of NOx and an exhaust amount of smoke in an real machine of the internal combustion engine is performed between the conventional example and Example 1 of the present invention, from which it is understood that the exhaust amount of smoke in combustion where occurrence of NOx is suppressed is reduced by 15% in Example 1 of the present invention as compared with the conventional example, and occurrence of NOx is suppressed in Example 1 of the present invention when comparison is performed regarding the same exhaust amount of smoke between the conventional example and Example 1 of the present invention.

Further, FIG. 5 is a diagram showing a relationship between a fuel consumption based upon BSFC (Break Specific Fuel Consumption) index and an exhaust amount of NOx, which shows that the fuel consumption is improved by about 2% in Example 1 of the present invention example under a combustion condition where the same amount of NOx is exhausted in the conventional example and Example 1 of the present invention example.

From the results shown in FIG. 3 to FIG. 5, since the fuel injection system according to the present invention suppresses pressure pulsation generated due to fuel injection as compared with the fuel injection system having the conventional structure to make reduction of a peak pressure acting on the fuel injection pipe possible, a set pressure of the common rail system (the high-pressure supply pump, the common rail, and the injector) can be raised, which shows a large effect on suppression of an exhaust amount of smoke.

Furthermore, since it is also possible to raise an injection pressure during injection, it is unnecessary to raise the injection pressure of the common rail system itself beyond necessity, so that size reduction of the common rail system (the pump, the rail, and the injector) can be achieved.

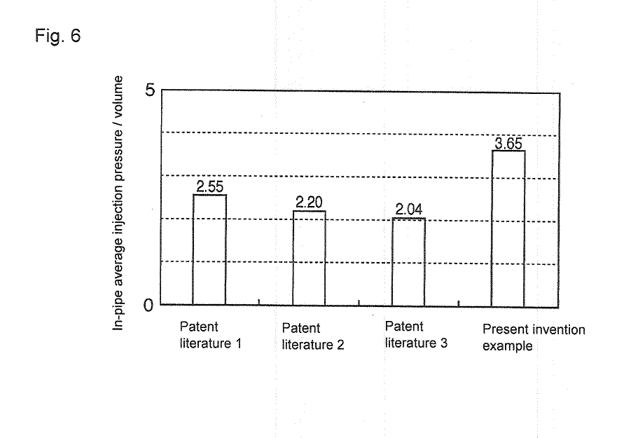

Next, comparison was performed regarding a value obtained by dividing an average pressure within an injection pipe by a whole volume of the fuel injection system (namely, an average injection pressure value within the injection pipe per unit volume of the fuel injection system) in order to fairly evaluate the fuel injection systems of the conventional examples shown in Patent Literatures 1 to 3 and an effect of an added volume in the fuel injection system of the present invention example of Example 1 to the average injection pressure correlated with an exhaust gas performance. The result of the comparison is shown in FIG. 6.

The present invention example shows a high value to the respective conventional examples and the fuel injection system according to the present invention is also superior in exhaust gas performance to the respective conventional examples.

### Example 2

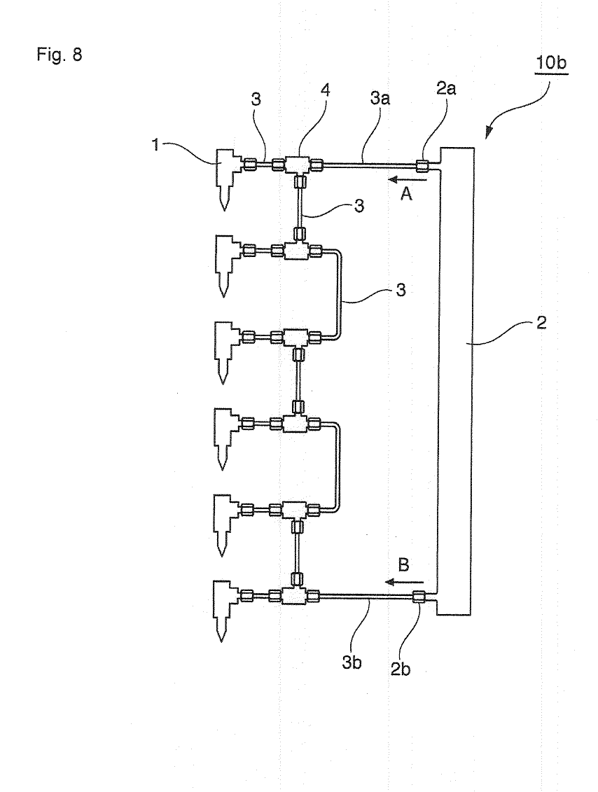

A schematic view of a fuel injection system 10b according to Example 2 is shown in FIG. 8.

The fuel injection system 10b of Example 2 is one for the same 6-cylinder diesel internal combustion engine as that of Example 1, Example 2 being the same as Example 1 such that the number NI of injectors 1 provided is also six, the number NP of pressure supply ports provided in the common rail 2 is also two (2a and 2b), and fuel where pressures in the fuel supply routes A and B of two lines have been averaged via each of coupling connectors 4 is supplied to a corresponding injector 1 to be injected into a corresponding cylinder.

A difference from Example 1 lies in a point that fuel is fed from each coupling connector 4 to a corresponding injector 1 via a fuel injection pipe 3. By feeding fuel via the fuel injection pipe 3, such a merit can be provided that the degree of freedom of arrangement of the fuel injection system within the engine room is increased.

### Example 3

A schematic view of a fuel injection system 10c according to Example 3 is shown in FIG. 9.

The fuel injection system 10c of Example 3 is one for the same 6-cylinder diesel internal combustion engine as those of Examples 1 and 2, Example 3 being the same as Examples 1 and 2 such that the number NI of injectors 1 provided is also six and the number NP of pressure supply ports provided in the common rail 2 is also two (2a and 2b), but it is a fuel injection system of a type where fuels from fuel supply routes A and B of two lines are directly fed to two fuel intake ports 6 and 6 provided in each injector 1 without interposition of any coupling connector as in Examples 1 and 2, averaging of fuel pressures within an injector 1 is performed, and injection into a corresponding cylinder is then performed.

### Example 4

A schematic view of a fuel injection system according to Example 4 is shown in FIG. 10.

The fuel injection system 10d of Example 4 is one for the same 6-cylinder diesel internal combustion engine as those of Examples 1 to 3, which has 6 injectors 1 (NI=6) and has pressure supply ports 2a, 2b, 2c and 2d provided in the common rail 2 having four ports {(N_{P}=2×(6/3)), and supplies high-pressure fuel to three injectors 1 (x₁ group) connected in series through the pressure supply ports 2a and 2b and the fuel injection pipes 3a and 3b communicating therewith, respectively and further supplies high-pressure fuel to three injectors 1 (x₂ group) connected in series via the pressure supply ports 2c and 2d and the fuel injection pipes 3c and 3d communicating therewith, respectively.

In the fuel injection system 10d of Example 4, supply of fuel to each injector 1 is performed regarding the x₁ group and the x₂ group which include three injectors according to division, respectively, such that: regarding the x₁ group, fuels are fed to a coupling connector 4 from two directions of a fuel supply line A₁ where fuel flows through the pressure supply port 2a and the fuel injection pipe 3a and a fuel supply line B₁ where fuel flows through the pressure supply port 2b and the fuel injection pipe 3b, and after pressures of the fuels are averaged in the coupling connector 4, the fuels are supplied to an injector 1 coupled to the coupling connector 4 by a connection nut 5 to be injected into a targeted cylinder; and regarding the group x₂ composed of the other three injectors, fuels are fed to a coupling connector 4 from two directions of a fuel supply line A₂ where fuel flows through the pressure supply port 2c and the fuel injection pipe 3c and a fuel supply line B₂ where fuel flows through the pressure supply port 2d and the fuel injection pipe 3d, and after pressures of the fuels are averaged in the coupling connector 4, the fuels are supplied to an injector 1 coupled to the coupling connector 4 by a connection nut 5 to be injected into a targeted cylinder.

As for the injector 1, an injector of a type similar to that in Example 1 is used.

In Example 4, since the number of injectors to which fuel is supplied is three which is a half of the number of injectors in Examples 1 to 3, the stroke of fuel is short, which has an advantage for pressure fluctuation in the fuel injection pipe.

### Example 5

A schematic view of a fuel injection system according to Example 5 is shown in FIG. 11.

A fuel injection system 10e of Example 5 is a fuel injection system of a type similar to that in Example 4 This system 10e is one for the 6-cylinder diesel internal combustion engine as those of Examples 1 to 3, which has six injectors 1 (N_{I}=6) and has pressure supply ports 2a, 2b, 2c, and 2d provided in a common rail 2 having four ports {(N_{P}=2×(6/3))}, and supplies high-pressure fuel to three injectors (the x₁ group) connected in series through the pressure supply ports 2a and 2b and the fuel injection pipes 3a and 3b communicating therewith, respectively, and further supplies high-pressure fuel to three injectors (the x₂ group) connected in series through the pressure supply ports 2c and 2d and the fuel injection pipes 3c and 3d communicating therewith, respectively.

In the fuel injection system 10e of Example 5, supply of fuel to each injector 1 is performed regarding a x₁ group and a x₂ group which include three injectors according to division, respectively, such that: regarding the x₁ group, fuels are fed to a coupling connector 4 from two directions of a fuel supply line A₁ where fuel flows through the pressure supply port 2a and the fuel injection pipe 3a and a fuel supply line B₁ where fuel flows through the pressure supply port 2b and the fuel injection pipe 3b, and after pressures of the fuels are averaged in the coupling connector 4, the fuels are supplied to an injector 1 coupled to the coupling connector 4 by a fuel injection pipe 3 to be injected into a targeted cylinder; and regarding the group x₂ composed of the other three injectors, fuels are fed to a coupling connector 4 from two directions of a fuel supply line A₂ where fuel flows through the pressure supply port 2c and the fuel injection pipe 3c and a fuel supply line B₂ where fuel flows through the pressure supply port 2d and the fuel injection pipe 3d, and after pressures of the fuels are averaged in the coupling connector 4, the fuels are supplied to an injector 1 coupled to the coupling connector 4 by a fuel injection pipe 3 to be injected into a targeted cylinder.

As for the injector 1, an injector of a type similar to that in Example 2 is used.

In Example 5, since the number of injectors to which fuel is supplied is three which is a half of the number of injectors in Examples 1 to 3, the stroke of fuel is short, which has an advantage for pressure fluctuation in the fuel injection pipe.

The fuel injection system 10e of Example 5 is different from the fuel injection system 10d of Example 4 in that the injector 1 is connected to the coupling connector 4 through the fuel injection pipe 3 in the former.

### Example 6

A schematic view of a fuel injection system according to Example 6 is shown in FIG. 12.

The fuel injection system 10f of Example 6 is a fuel injection system of a type similar to that in Example 4.

This system 10f is also one for the 6-cylinder diesel internal combustion chamber as those of Examples 1 to 5, which has six injectors 1 (N_{I}=6) and has pressure supply ports 2a, 2b, 2c, and 2d provided in a common rail 2 having four ports {(N_{P}=2×(6/3))}, and supplies high-pressure fuel to three injectors (the x₁ group) connected in series through the pressure supply ports 2a and 2b and the fuel injection pipes 3a and 3b communicating therewith, respectively, and further supplies high-pressure fuel to three injectors (the x₂ group) connected in series through the pressure supply ports 2c and 2d and the fuel injection pipes 3c and 3d communicating therewith, respectively.

It is to be noted that the injectors 1 used in Example 6 have a type similar to those of Example 3, has and each injector has two fuel intake ports 6 and performs averaging of fuel pressures within the injector.

In the fuel injector system 10f of Example 6, like the case of Examples 4 and 5, supply of fuel to each injector 1 is performed regarding a group x₁ and a group x₂ including three injectors according to division, respectively, such that: regarding the x₁ group, fuels are fed to two fuel intake ports 6 provided on an injector 1 from two directions of a fuel supply line A₁ where fuel flows through the pressure supply port 2a and the fuel injection pipe 3a and a fuel supply line B₁ where fuel flows through the pressure supply port 2b and the fuel injection pipe 3b, and after pressures of the fuels are averaged within the injector 1, the fuels are injected into a targeted cylinder; and regarding the x₂ group composed of the other three injectors, fuels are fed to two fuel intake ports 6 provided on an injector 1 from two directions of a fuel supply line A₂ where fuel flows through the pressure supply port 2c and the fuel injection pipe 3c and a fuel supply line B₂ where fuel flows through the pressure supply port 2d and the fuel injection pipe 3d, and after pressures of the fuels are averaged within the injector 1, the fuels are injected into a targeted cylinder.

In Example 6, since the number of injectors to which fuel is supplied is three which is a half of the number of injectors in Examples 1 to 3, the stroke of fuel is short, which has an advantage for pressure fluctuation in the fuel injection pipe.

The fuel injection system 10f is different from the fuel injection systems 10d and 10e of Examples 4 and 5 in that the averaging of fuel pressure is performed within the injector 1 in the fuel injection system 10f.

### Example 7

A schematic view of a fuel injection system according to Example 7 is shown in FIG. 13.

The fuel injection system 10g of Example 7 is one for a 3-cylinder diesel internal combustion engine, which has three injectors 1 (N_{I}=3), and supplies high-pressure fuel to three injectors connected in series from the pressure supply ports 2a and 2b provided in the common rail 2 having two ports {(N_{P}=2×(3/3))} through the fuel injection pipes 3a and 3b communicating with the pressure supply ports 2a and 2b, respectively.

In the fuel injection system 10g of Example 7, supply of fuel to each injector 1 is performed such that fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied to an injector 1 coupled to the coupling connector 4 by a connection nut 5 to be injected to a corresponding cylinder.

### Example 8

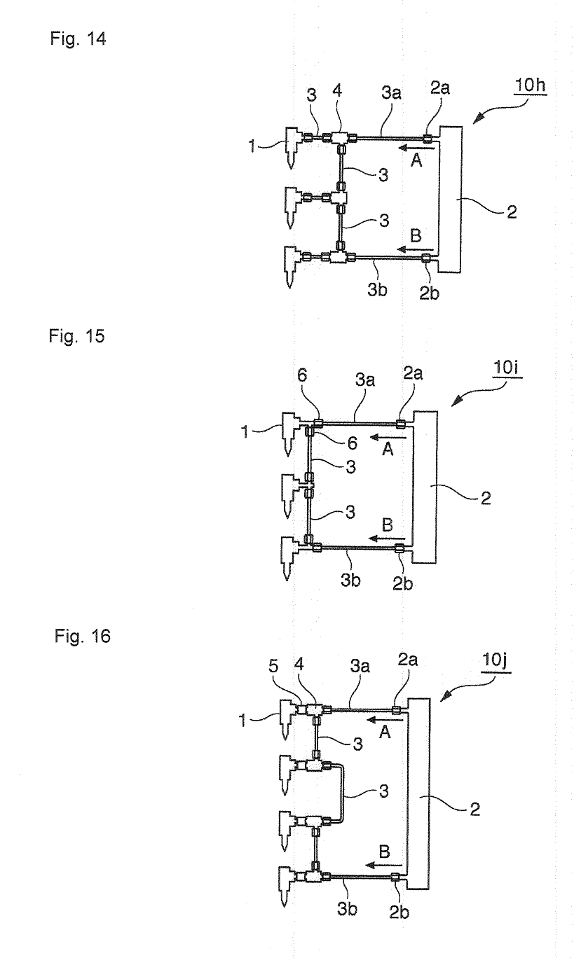

A schematic view of a fuel injection system according to Example 8 is shown in FIG. 14.

The fuel injection system 10h of Example 8 is a fuel injection system of a type similar to that in Example 7.

The fuel injection system 10h of Example 8 is one for a 3-cylinder diesel internal combustion engine, which has three injectors 1 (N_{I}=3), and supplies high-pressure fuel to three injectors connected in series from the pressure supply ports 2a and 2b provided in the common rail 2 having two ports {(N_{P}=2×(3/3))} through the fuel injection pipes 3a and 3b communicating with the pressure supply ports 2a and 2b, respectively.

In the fuel injection system 10h, supply of fuel to each injector 1 is performed such that fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied to an injector 1 coupled to the coupling connector 4 by a fuel injection pipe 3 to be injected to a corresponding cylinder.

### Example 9

A schematic view of a fuel injection system according to Example 9 is shown in FIG. 15.

A fuel injection system 10i of Example 9 is a fuel injection system of a type similar to those in Examples 7 and 8.

The fuel injection system 10i of Example 9 is one for a 3-cylinder diesel internal combustion engine, which has three injectors 1 (NI=3), and supplies high-pressure fuel to three injectors connected in series from the pressure supply ports 2a and 2b provided in the common rail 2 having two ports {(NP=2×(3/3))} through the fuel injection pipes 3a and 3b communicating with the pressure supply ports 2a and 2b, respectively.

It is to be noted that the injectors 1 used in Example 9 have a type similar to those of Example 3, and each injector has two fuel intake ports 6 and performs averaging of fuel pressures within the injector.

In the fuel injection system 10i, supply of fuel to each injector 1 is performed such that high-pressure fuels fed from two lines of a fuel supply line A where fuel flows through the pressure supply port 2a and the fuel injection pipe 3a and a fuel supply line B where fuel flows through the pressure supply port 2b and the fuel injection pipe 3b are supplied to an injector 1 from two fuel intake ports 6 thereof, and after fuel pressures of the fuels are averaged in the injector 1, they are injected into a corresponding cylinder.

### Example 10

A schematic view of a fuel injection system according to Example 10 is shown in FIG. 16.

A fuel injection system 10j of Example 10 is one for a four-cylinder diesel internal combustion engine, which has four injectors 1 (NI=4), and supplies high-pressure fuel to four injectors connected in series from the pressure supply ports 2a and 2b provided in the common rail 2 having two ports {(NP=2×(4/4))} through the fuel injection pipes 3a and 3b communicating with the pressure supply ports 2a and 2b, respectively.

In the fuel injection system 10j of Example 10, supply of fuel to each injector 1 is performed such that fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied to an injector 1 coupled to the coupling connector 4 by a connection nut 5 to be injected to a corresponding cylinder.

As for the injector 1, one of a type similar to that of Example 1 is used.

### Example 11

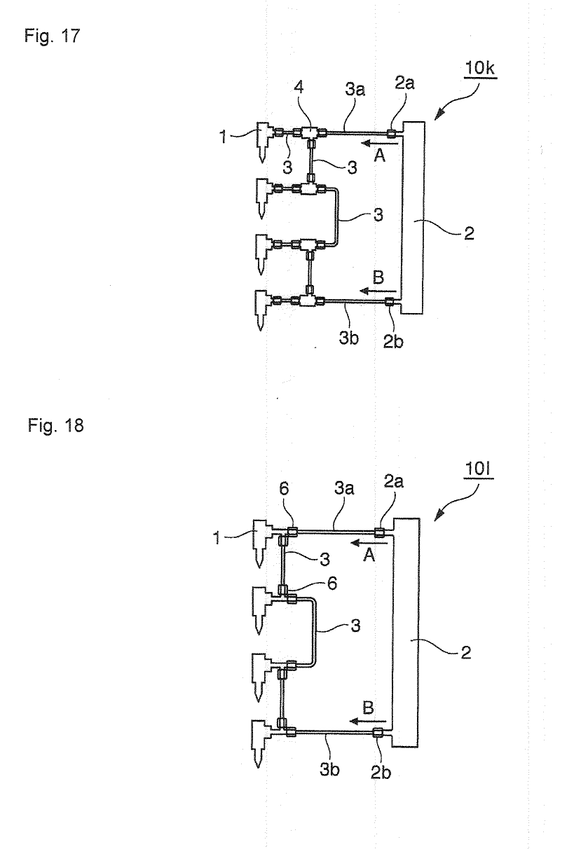

A schematic view of a fuel injection system of Example 11 is shown in FIG. 17.

A fuel injection system 10k of Example 11 is a fuel injection system of a type similar to that of Example 10.

This system 10k is one for a four-cylinder diesel internal combustion engine, which has four injectors 1 (NI=4), and supplies high-pressure fuel to four injectors connected in series from the pressure supply ports 2a and 2b provided in the common rail 2 having two ports {(NP=2×(4/4))} through the fuel injection pipes 3a and 3b communicating with the pressure supply ports 2a and 2b, respectively.

In the fuel injection system 10k of Example 11, supply of fuel to each injector 1 is performed such that fuels which are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied to an injector 1 coupled to the coupling connector 4 through a fuel injection pipe 3 to be injected to a corresponding cylinder.

As for the injector 1, one of a type similar to that of Example 2 is used.

### Example 12

A schematic view of fuel injection system of Example 12 is shown in FIG. 18.

A fuel injection system 101 of Example 12 is a fuel injection system of a type similar to that of Example 10.

The fuel injection system 10k of Example 11 is one for a four-cylinder diesel internal combustion engine, which has four injectors 1 (NI=4), and supplies high-pressure fuel to four injectors 1 connected in series from the pressure supply ports 2a and 2b provided in the common rail 2 having two ports {(NP=2×(4/4))} through the fuel injection pipes 3a and 3b communicating with the pressure supply ports 2a and 2b, respectively.

It should be noted that the injectors 1 used in Example 12 have a type similar to those of Example 3, and each injector has two fuel intake ports 6 and performs averaging of fuel within the injector.

In the fuel injection system 101 of Example 12, supply of fuel to each injector 1 is performed such that high-pressure fuels which have been fed from two directions of a fuel supply line A where fuel flows through the pressure supply port 2a and the fuel injection pipe 3a and a fuel supply line B where fuel flows through the pressure supply port 2b and the fuel injection pipe 3b are supplied through two fuel intake ports 6 into an injector 1, and after fuels pressures are averaged in the injector 1, they are injected into a corresponding cylinder.

### Example 13

FIG. 19 is a schematic view of fuel injection system according to Example 13.

In FIG. 19, reference sign 1 denotes an injector; 2 denotes a common rail; 2a, 2b denotes a pressure supply port provided in the common rail 2; 3, 3a, 3b denotes a fuel injection pipe; 4 denotes a coupling connector; and 5 denotes a connection nut.

A fuel injection system 10m of Example 13 is one for a 5-cylinder internal combustion engine, which has five injectors (NI=5), and supplies high-pressure fuels to five injectors connected in series from the pressure supply ports 2a and 2b provided in the common rail 2 having two ports {(NP=2×(5/5))} through the fuel injection pipes 3a and 3b communicating with the pressure supply ports 2a and 2b, respectively.

In the fuel injection system 10m, supply of fuel to each injector 1 is performed such that high-pressure fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged at the coupling connector 4, the fuels are then supplied to an injector 1 coupled to the coupling connector 4 by a connection nut 5 to be injected to a corresponding cylinder.

As for the injector 1, one of a type similar to that of Example 1 is used.

### Example 14

A schematic view of fuel injection system of Example 14 is shown in FIG. 20.

A fuel injection system 10n of Example 14 is one for a 5-cylinder diesel internal combustion engine like Example 13.

The fuel injection system 10n is one for a 5-cylinder diesel internal combustion engine, which has five injectors (NI=5), and supplies high-pressure fuels to five injectors connected in series from the pressure supply ports 2a and 2b provided in the common rail 2 having two ports {(NP=2×(5/5))} through the fuel injection pipes 3a and 3b communicating with the pressure supply ports 2a and 2b, respectively.

In the fuel injection system 10n of Example 14, supply of fuel to each injector 1 is performed such that high-pressure fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied from the coupling connector 4 to an injector 1 through a fuel injection pipe 3 to be injected to a corresponding cylinder.

As for the injector 1, one of a type similar to that of Example 2 is used.

### Example 15

A schematic view of fuel injection system of Example 15 is shown in FIG. 21.

A fuel injection system 10o of Example 15 is one for a 5-cylinder diesel internal combustion engine like Example 13 and Example 14.

It should be noted that the injectors 1 of Example 15 have a type similar to those of Example 3, and each injector has two fuel intake ports 6 and performs averaging of fuel pressures within the injector.

The fuel injection system 10o is one for a 5-cylinder diesel fuel injection system, which has five injectors 1 (NI=5), and supplies high-pressure fuels to five injectors 1 connected in series from the pressure supply ports 2a and 2b provided in the common rail 2 having two ports {(NP=2×(5/5))} through the fuel injection pipes 3a and 3b communicating with the pressure supply ports 2a and 2b, respectively.

In the fuel injection system 10o of Example 15, supply of fuel to each injector 1 is performed such that high-pressure fuels from two directions of a fuel supply line A where fuel flows through the pressure supply port 2a and the fuel injection pipe 3a and a fuel supply line B where fuel flows through the pressure supply port 2b and the fuel injection pipe 3b are fed through two fuel intake ports 6 provided on an injector 1 to the injector 1, and after pressures of the fuels are averaged in the injector 1, the fuels are injected into a corresponding cylinder.

### Example 16

A schematic view of fuel injection system of Example 16 is shown in FIG. 22.

In FIG. 22, reference sign 1 denotes an injector; 2 denotes a common rail; 2a, 2b denotes a pressure supply port provided in the common rail 2; 3, 3a, 3b denotes a fuel injection pipe, 4 denotes a coupling connector; 5 denotes a connection nut; and 10p denotes a fuel injection system of this Example.

The fuel injection system 10p of Example 16 is one for an 8-cylinder diesel internal combustion engine, which has 8 injectors (NI=8), and supplies high-pressure fuels to the eight injectors connected in series from pressure supply ports 2a and 2b provided in the common rail 2 having two ports {(NP=2×(8/8)) through the fuel injection pipes 3a and 3b communicating with pressure supply ports 2a and 2b, respectively.

In the fuel injection system 10p of Example 16, supply of fuel to each injector 1 is performed such that high-pressure fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied to an injection 1 coupled to the coupling connector 4 by a connection nut 5 to be injected into a corresponding cylinder.

As for the injector 1, one of a type similar to that of Example 1 is used.

### Example 17

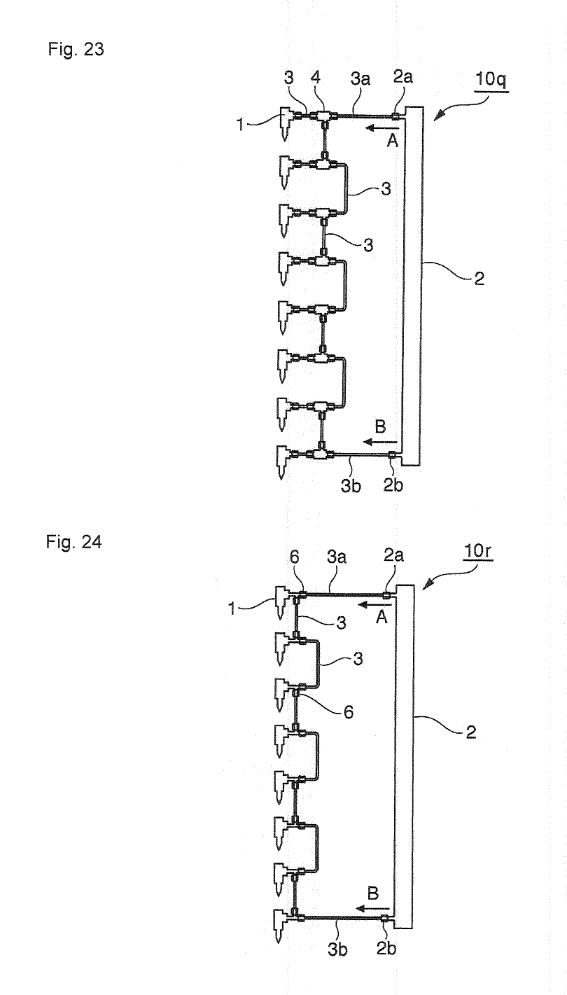

A schematic view of a fuel injection system of Example 17 is shown in FIG. 23.

A fuel injection system 10q of Example 17 is a fuel injection system for an 8-cylinder diesel internal combustion chamber like Example 16.

The fuel injection system 10q is one for an 8-cylinder diesel internal combustion engine, which has eight injectors (NI=8), and supplies high-pressure fuels to the eight cylinders 1 connected in series from the pressure supply ports 2a and 2b provided in the common rail 8 having two ports {(NP=2×(8/8))} through the fuel injection pipes 3a and 3b communicating with the pressure supply ports 2a and 2b, respectively.

In the fuel injection system 10q of Example 17, supply of fuel to each injector 1 is performed such that high-pressure fuels are fed to a coupling connector 4 from two directions of a fuel supply line A where fuel flows through the pressure supply port 2a and the fuel injection pipe 3a and a fuel supply line B where fuel flows through the pressure supply port 2b and the fuel injection pipe 3b, and after pressures of the fuels are averaged in the coupling connector 4, the fuels are supplied to an injection 1 from the coupling connector 4 through a fuel injection pipe 3 to be injected into a corresponding cylinder.

As for the injector 1, one of a type similar to that of Example 2 is used.

### Example 18

A schematic view of fuel injection system of Example 18 is shown in FIG. 24.

A fuel injection system 10r of Example 18 is a fuel injection system for an 8-cylinder diesel internal combustion chamber like Examples 16 and 17.

The fuel injection system 10r is one for an 8-cylinder diesel internal combustion engine, which has eight injectors (NI=8), and supplies high-pressure fuels to the eight cylinders 1 connected in series from the pressure supply ports 2a and 2b provided in the common rail 8 having two ports {(NP=2×(8/8))} through the fuel injection pipes 3a and 3b communicating with the pressure supply ports 2a and 2b, respectively.

It is to be noted that the injectors 1 of Example 18 have a type similar to those of Example 3, and each injector has two fuel intake ports 6 and performs averaging of fuel pressures within the injector.

In the fuel injection system 10r of Example 18, supply of fuel to each injector 1 is performed such that high-pressure fuels from two directions of a fuel supply line A where fuel flows through the pressure supply port 2a and the fuel injection pipe 3a and a fuel supply line B where fuel flows through the pressure supply port 2b and the fuel injection pipe 3b are supplied to an injector 1 through two fuel intake ports 6 provided on the injector 1, and after pressures of the fuels are averaged in the injector 1, the fuels are injected into a corresponding cylinder.

### Example 19

A schematic view of fuel injection system of Example 19 is shown in FIG. 25.

A fuel injection system 10s of Example 19 is a fuel injection system for an 8-cylinder diesel internal combustion engine like Examples 16 to 18.

The fuel injection system 10s is one for the 8-cylinder diesel internal combustion engine, which has eight injectors (NI=8) and has pressure supply ports 2a, 2b, 2c, and 2d provided in the common rail 2 having four ports {(Np=2×(8/4))}, and supplies high-pressure fuels to four injectors 1 (x1 group) connected in series through the pressure supply ports 2a and 2b and the fuel injection pipes 3a and 3b communicating with the pressure supply ports 2a and 2b, respectively, and further supplies high-pressure fuels to four injectors 1 (x2 group) connected in series through the pressure supply ports 2c and 2d and the fuel injection pipes 3c and 3d communicating with the pressure supply ports 2c and 2d, respectively,

In the fuel injection system 10s of Example 19, supply of fuel to each injector 1 is performed regarding an x1 group and an x2 group which include four injectors according to division, respectively, such that: regarding the x1 group, fuels are fed to a coupling connector 4 from two directions of a fuel supply line A1 where fuel flows through the pressure supply port 2a and the fuel injection pipe 3a and a fuel supply line B1 where fuel flows through the pressure supply port 2b and the fuel injection pipe 3b, and after pressures of the fuels are averaged in the coupling connector 4, the fuels are supplied to an injector 1 coupled to the coupling connector 4 by a connection nut 5 to be injected into a targeted cylinder; and regarding the x2 group composed of the other four injectors, fuels are fed to a coupling connector 4 from two directions of a fuel supply line A2 where fuel flows through the pressure supply port 2c and the fuel injection pipe 3c and a fuel supply line B2 where fuel flows through the pressure supply port 2d and the fuel injection pipe 3d, and after pressure of the fuels are averaged in the coupling connector 4, the fuels are supplied to an injector 1 coupled to the coupling connector 4 by a connection nut 5 to be injected into a targeted cylinder.

As for the injector 1, one of a type similar to that of Example 1 is used.

In Example 19, since the number of injectors to which fuel is supplied becomes four which is a half of the number of injectors in Examples 16 to 18, which use the same type of fuel injection system for an 8-cylinder diesel internal combustion engine as that of Example 19, the stroke of fuel is short, which has an advantage for pressure fluctuation in the fuel injection pipe.

### Example 20

A schematic view of fuel injection system of Example 20 is shown in FIG. 26.

A fuel injection system 10t of Example 20 is a fuel injection system for an 8-cylinder diesel internal combustion engine like Examples 16 to 19.

The fuel injection system 10t is one for the 8-cylinder diesel internal combustion engine, which has eight injectors (NI=8) and has pressure supply ports 2a, 2b, 2c, and 2d provided in the common rail 2 having four ports {(NP=2×(8/4))}, and supplies high-pressure fuels to four injectors 1 (x1 group) connected in series through the pressure supply ports 2a and 2b and fuel injection pipes 3a and 3b communicated with the pressure supply ports 2a and 2b, respectively, and further supplies high-pressure fuels to four injectors 1 (x2 group) connected in series through the pressure supply ports 2c and 2d and fuel injection pipes 3c and 3d communicated with the pressure supply ports 2c and 2d, respectively.

In the fuel injection system 10t of Example 20, supply of fuel to each injector 1 is performed regarding an x1 group and an x2 group which include four injectors according to division, respectively, such that: regarding the x1 group, fuels are fed to a coupling connector 4 from two directions of a fuel supply line A1 where fuel flows through the pressure supply port 2a and the fuel injection pipe 3a and a fuel supply line B1 where fuel flows through the pressure supply port 2b and the fuel injection pipe 3b and, after pressures of the fuel are averaged in the coupling connector 4, the fuels are supplied to an injector 1 coupled to the coupling connector 4 through a fuel injection pipe 3 to be injected into a targeted cylinder; and regarding the x2 group composed of the other four injectors, fuels are fed to a coupling connector 4 from two directions of a fuel supply line A2 where fuel flows through the pressure supply port 2c and the fuel injection pipe 3c and a fuel supply line B2 where fuel flows through the pressure supply port 2d and the fuel injection pipe 3d, and after pressures of the fuel are averaged in the coupling connector 4, the fuels are supplied to an injector 1 coupled to the coupling connector 4 through a fuel injection pipe 3 to be injected into a targeted cylinder.

As for the injector 1, one of a type similar to that of Example 2 is used.

### Example 21

A schematic view of fuel injection system of Example 21 is shown in FIG. 27.

A fuel injection system 10u of Example 21 is a fuel injection system for an 8-cylinder diesel internal combustion engine like Examples 16 to 20.

The fuel injection system 10u is one for the 8-cylinder diesel internal combustion engine, which has eight injectors (NI=8) and has pressure supply ports 2a, 2b, 2c, and 2d provided in the common rail 2 having four ports {(NP=2×(8/4))}, and supplies high-pressure fuels to four injectors 1 (x1 group) connected in series through the pressure supply ports 2a and 2b and fuel injection pipes 3a and 3b communicated with the pressure supply ports 2a and 2b, respectively, and further supplies high-pressure fuels to four injectors 1 (group x2) connected in series through the pressure supply ports 2c and 2d and fuel injection pipes 3c and 3d communicated with the pressure supply ports 2c and 2d, respectively.

In the fuel injection system 10u of Example 21, supply of fuel to each injector 1 is performed regarding an x1 group and an x2 group which include four injectors according to division, respectively, such that: regarding the x1 group, fuels supplied from two directions of a fuel supply line A1 where fuel flows through the pressure supply port 2a and the fuel injection pipe 3a and a fuel supply line B1 where fuel flows through the pressure supply port 2b and the fuel injection pipe 3b are fed to two fuel intake ports 6 provided on an injector 1, respectively, and after pressures of the fuel are averaged in the injector 1, the fuels are injected into a targeted cylinder; and regarding the x2 group composed of the other four injectors, fuels supplied from two directions of a fuel supply line A2 where fuel flows through the pressure supply port 2c and the fuel injection pipe 3c and a fuel supply line B2 where fuel flows through the pressure supply port 2d and the fuel injection pipe 3d are fed to two fuel intake ports 6 of an injector 1, respectively, and after pressures of the fuels are averaged in the injector 1, the fuels are injected into a targeted cylinder.

It should be noted that as the injector 1, one of a type similar to that of Example 3 is used.

1. A common rail fuel injection system comprising:
injectors having a fuel intake port and being provided for respective cylinders of a multi-cylinder diesel internal combustion engine;
a common rail accumulating pressurized fuel to be supplied to the injectors;
a high-pressure supply pump supplying high-pressure fuel to the common rail;
a fuel supply pipe causing the common rail and the high-pressure supply pump to communicate with each other; and
fuel injection pipes communicating with pressure supply ports provided in the common rail and causing the injectors and the pressure supply ports provided in the common rail to communicate with each other, wherein
the fuel injection pipes cause at least three injectors to communicate with one another in series,
the number NP of the pressure supply ports provided in the common rail is less than the number NI of the injectors, and
supply of high-pressure fuel to the respective injectors for the cylinders is performed though fuel injection pipes of two lines.

2. The common rail fuel injection system according to claim 1, wherein the multi-cylinder diesel internal combustion engine is a diesel internal combustion engine having at least three cylinders.

3. The common rail fuel injection system according to claim 2, wherein the multi-cylinder diesel internal combustion engine is a diesel internal combustion engine equipped with at least three injectors.

4. The common rail fuel injection system according to claim 1, wherein the relationship between the number of pressure supply ports provided in the common rail and the number of injectors is set such that the number of twice the number obtained by dividing the number NI of injectors by an aliquot which is three or more in aliquots of the number NI of injectors coincides with the number NP of pressure supply ports as shown in the following Equation.
NP=2×{NI/(an aliquot which is three of more in aliquots of NI)} (3)
